(19) United States
(12) Patent Application Publication
(10) Pub. No.: US 2010/0064362 A1
(43) Pub. Date: Mar. 11, 2010

(54) SYSTEMS AND METHODS FOR VOIP NETWORK SECURITY

(75) Inventors: Bogdan Materna, Ottawa (CA); Jacek Materna, Kanata (CA); Andriy Markov, Ottawa (CA); Bogdan Gawronski, Nepean (CA); Czeslaw Siemaszko, Ottawa (CA); Nothapol (Rody) Piyasin, Bangkok (TH)

Correspondence Address: Pearne & Gordon LLP, 1801 East 9th Street, Suite 1200, Cleveland, OH, 44114-3108, US

(73) Assignee: VolPshield Systems Inc., Ottawa (CA)

(21) Appl. No.: 12/205,212

(22) Filed: Sep. 5, 2008

(51) Int. Cl. H04W 28/12

(52) U.S. Cl. 726/15

(57) ABSTRACT

According to an aspect of the present invention there is provided a VoIP asset discovery system for discovering and identifying VoIP assets on a VoIP network, the asset discovery system comprising an IP address module for determining at least one IP address to discover, a port scanner for scanning VoIP specific ports of the received IP addresses, a service detection module for detecting a VoIP service at the received IP addresses. The asset discovery system further comprises a fingerprinting module for fingerprinting VoIP applications based on responses received to specific queries and a correlation module for correlating the information from the port scanner module, the service detection module, and the fingerprinting module to identify the instances of the discovered assets.

### FIELD OF INVENTION

The present disclosure relates to Voice over Internet Protocol (VoIP) networks and more particularly to VoIP security systems.

### BACKGROUND OF THE INVENTION

The emergence of VoIP technology is creating a major discontinuity in telecommunications. The promise of reduced hardware and operations costs coupled with a promise of new add-value services makes VoIP services a compelling solution for enterprises and service providers. At the same time VoIP introduces a set of new problems for the network operators and services providers. Current voice services provide high voice quality, very high reliability (99.999%), carry critical services such as E911, provides federal agencies with the ability for lawful intercept are very secure and operate on well established PSTN networks.

There are however several issues that need to be addressed if there is to be a widespread acceptance of VoIP. Security of Voice over IP (VoIP) is considered as one of the prime concerns and barriers that could significantly delay deployment of VoIP networks.

VoIP is not just another application running on the top of the IP infrastructure. VoIP is a complex service with its own business models and set of features offered to the end-user, similar to existing PSTN and Private Branch eXchange (PBX) offerings. Over the years, service providers and PBX vendors have established their respective brands as being synonymous with high levels of reliability, quality and security and need to preserve these attributes in their VoIP offerings.

VoIP uses a two stage process to provide real-time voice services. In the first stage a signaling protocol is used to establish a connection between two end-point devices such as phones. During that process various call and network parameters are configured. Once the connection is established a real-time transport protocol is used to carry packetized voice between the end-points.

VoIP characteristics such high sensitivity to Quality of Service (QoS) parameters, real-time nature of the service, a wide range of infrastructure devices, protocols and applications, and interaction with the existing phone networks require different techniques and methodologies that will support PSTN like security and reliability.

VoIP QoS sensitivity to packet delay, packet loss, and packet jitter makes most of the existing security solutions designed for protecting data networks inadequate.

VoIP is a real time service, i.e., it is happening in real-time and generally no information is stored anywhere on the network. As result any loss of information cannot be recovered or retransmitted. This makes the VoIP services very susceptible to worms and DoS attacks that could very easily disrupt voice communication.

Also the complex nature of VoIP infrastructure, comprising a wide range of components and applications such as telephone handsets, conferencing units, mobile units, call processors/call managers, gateways, routers, firewalls, and specialized protocols creates new and unique security attack vectors.

The VoIP security threats can be categorized in three distinct functional categories: attacks that aim at compromising VoIP service availability, malicious activities whose goal is to compromise integrity of the services and eavesdropping.

VoIP high sensitivity to QoS parameters amplifies the threat of known attacks such as Denial of Service (DoS) attacks, viruses and worms. These threats may use VoIP specific protocols and VoIP application vulnerabilities to overload the network and impact VoIP QoS making the service unavailable. They may also attack critical VoIP applications such as end-user phones and soft-clients, call managers, authentication servers and billing applications.

VoIP service integrity can be compromised by toll fraud, identity theft and fraud attacks. For example, a hacker VoIP phone can be connected to the network and use a stolen or guessed user account and password to place phone calls at the victim's expense. Also VoIP conversations could be hijacked and the caller would be misled into communicating with the attacker, masquerading as a party to this call. In addition VoIP services are offered with many features such as, for example, call ID, call forward, voice mail, three-way calling, etc. Each of these features could potentially be used for toll fraud, identity theft and spam.

Eavesdropping on signaling and media paths allows the attacker to use Session Initiation Protocol (SIP), or other signaling protocols, messages and Real Time Protocol (RTP) packets to obtain sensitive business or personal information. It also allows creating various man-in-the-middle attacks altering the content of the conversation.

Most email users are familiar with receiving spam on a daily basis, or use filtering software to block the messages. Today spammers are also looking toward VoIP voicemail boxes as their latest targets.

As VoIP adoption continues to accelerate and technology is now available to block unwanted emails, it is reasonable to expect that Spam over Internet Protocol Telephony (SPIT) attacks will quickly follow. As organizations plan and deploy VoIP networks, SPIT should be considered a very real threat and proactively addressed as part of an overall security strategy.

Within the VoIP network, voice spammers will execute attacks in a manner similar to how they now do so using email, by harvesting user information, creating a script and sending messages. It will create a high level of inconvenience to both business and personal users as they are forced to deal with unwanted messages.

An influx of hundreds or thousands of voicemail each day, or even each hour, could quickly overload a system resulting in a Denial of Service (DoS) attack which would impact the overall reliability and availability of the VoIP network. For both public and private sector organizations, DoS-type attacks would clearly have significant consequences.

SPIT attacks may also take the form of automated mass calling and/or telemarketing type scams. In this scenario, using the IP network, spammers could falsify the caller id to reach users. With the traditional telephone network, users generally trust the system. These types of attacks would not only erode trust in the IP-based phone system but open up a whole new host of victims for spammers and scammers that they couldn't reach on email. This opportunistic practice could result in a major resistance to VoIP entering the mainstream, and this could seriously impact service providers and enterprises. For service providers, who have built their brands on trust, they cannot afford to have confidence in the security and integrity of their services called into question. VoIP is marketed on ease of use, low, controlled cost and convenience. SPIT may eliminate these benefits.

Enterprises rely heavily on the phone to conduct business, and they need to ensure that their customers know that it is actually them on the other end of the line, and not someone misrepresenting their organization.

### SUMMARY OF THE INVENTION

It is an object of the invention to provide an improved security of VoIP networks.

According to an aspect of the present invention there is provided a VoIP asset discovery system for discovering and identifying VoIP assets on a VoIP network, the asset discovery system comprising an IP address module for determining at least one IP address to discover, a port scanner for scanning VoIP specific ports of the received IP addresses, a service detection module for detecting a VoIP service at the received IP addresses. The asset discovery system further comprises a fingerprinting module for fingerprinting VoIP applications based on responses received to specific queries and a correlation module for correlating the information from the port scanner module, the service detection module, and the fingerprinting module to identify the instances of the discovered assets.

According to another aspect of the present invention there is provided a VoIP network security system for providing security measures to a VoIP network. The security system comprises a plurality of agents for discovering assets connected to the VoIP network, and for executing tests on the discovered assets, a management console for managing the plurality of agents, and for providing a user interface to the VoIP network security system and a reporting server for managing the storage of information and for creating report information.

According to another aspect of the present invention there is provided a SPIT blocking system for blocking SPIT traffic on a VoIP network. The SPIT blocking system comprises a SPIT detection engine for detecting SPIT traffic using a banned list, an asset rating system for associating a SPIT index value with an asset, and a list manager for maintaining the banned list wherein an asset is added to the banned list if the associated SPIT index value is greater then a threshold value.

According to another aspect of the present invention there is provided a method for discovering and identifying VoIP assets on a VoIP network. The method comprises the steps of determining at least one IP address to discover, scanning VoIP specific ports of the received IP addresses, detecting a VoIP service at the received IP addresses, fingerprinting VoIP applications based on responses received to specific queries, correlating the information from the scanning of VoIP specific ports, the detecting of the VoIP service, and the fingerprinting of VoIP applications, and identifying instances of the discovered assets using the correlated information.

According to another aspect of the present invention there is provided a method for providing security measures to a VoIP network. The method comprises the steps of discovering assets connected to the VoIP network, executing tests on the discovered assets, managing a plurality of agents used in discovering the assets and executing tests, providing a user interface to the VoIP network security system, managing the storage of information; and creating report information.

According to another aspect of the present invention there is provided a method for blocking SPIT traffic on a VoIP network. The method comprises the steps of detecting SPIT traffic using a banned list, associating a SPIT index value with an asset and maintaining the banned list. Maintaining the banned list comprises adding an asset to the banned list when the associated SPIT index value is greater then a threshold value.

### BRIEF DESCRIPTION OF THE DRAWINGS

These and other features of the invention will become more apparent from the following description in which reference is made to the appended drawings wherein:

FIG. 1 shows in a schematic diagram, an exemplary network environment in which the disclosed systems and methods may be practiced;

FIG. 2a shows in a functional schematic, components of the VoIP security vulnerability audit system in accordance with an embodiment of the present disclosure;

FIG. 2b shows in a functional schematic, components of the VoIP security vulnerability audit system in accordance with an embodiment of the present disclosure;

FIG. 3 shows in a functional schematic, components of the VoIP security compliance assessment system in accordance with an embodiment of the present disclosure;

FIG. 4 shows in a functional schematic, a VoIP Network Access Control system in accordance with an embodiment of the present disclosure;

FIG. 5 shows in a functional schematic, an asset discovery module in accordance with an embodiment of the present disclosure;

FIG. 6 shows in a schematic a SPIT blocking system in accordance with an embodiment of the present disclosure;

FIG. 7 depicts a system architecture of a further embodiment of the SPIT blocking system in accordance with the present disclosure;

FIG. 8 depicts in a schematic components for maintaining Black/White lists in accordance with the present disclosure; and

FIG. 9 there is shown in an exemplary flow diagram of the SPIT blocking system in accordance with the present disclosure.

### DETAILED DESCRIPTION

One or more currently preferred embodiments have been described by way of example. It will be apparent to persons skilled in the art that a number of variations and modifications can be made without departing from the scope of the invention as defined in the claims.

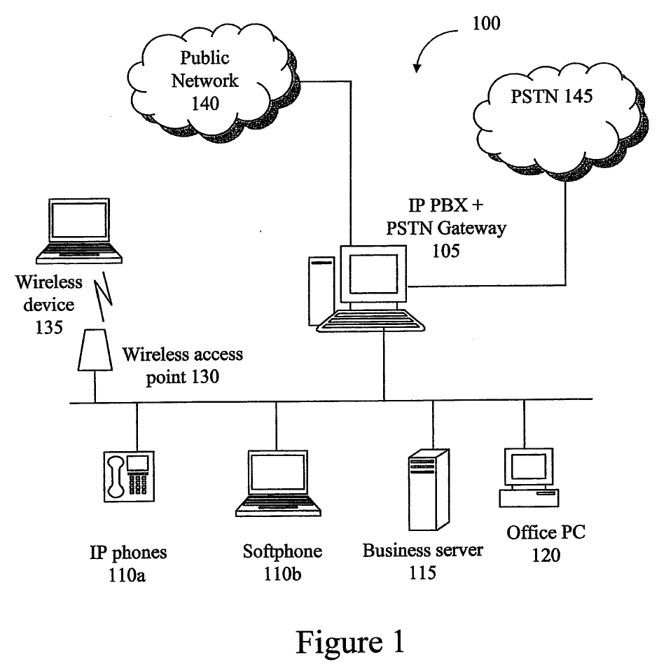

FIG. 1 shows in a schematic diagram an exemplary network environment 100 in which the disclosed systems and methods may be practiced. A VoIP network typically includes VoIP softswitch or PBX 105, hard 110a and soft phones 110b, gateways, voice mail systems, conference servers, multi-media servers, call recorders, automated call distribution systems and interactive voice response systems. The IP PBX 105 may connect a LAN 125 or other network to a public network 140 such as the Internet, as well as a public switched telephone network (PSTN) 145. The LAN 125 may include wireless access points 130 for communicating with wireless devices 135. Additionally the LAN 125 may include business servers 115 and office PCs 120. In many cases these networks can have a distributed nature, for example, a single central site with hundreds of branch offices. In other cases a service provider could have millions of end-points distributed throughout very large geographical areas. In a peer-to-peer VoIP implementation, VoIP PBX functionality is replaced with distributed call processing capabilities.

The systems and methods described herein may be used to provide increased security for VoIP networks. The system and methods may be embodied within a single product with multiple program components, or may be implemented as separate program components. The program components may include a security vulnerability assessment system, a security compliance system, and network access control system, and a SPIT blocking system. Each of the components are described individually. It is understood that, although the components are described individually, they may share common resources or modules, and/or may be presented and controlled as a single program.

### Security Vulnerability Audit System

An effective way of improving VoIP security levels is to a conduct VoIP security vulnerability assessment. VoIP specific vulnerability assessments may be performed before the VoIP equipment and applications are deployed, e.g., in the lab. This allows verifying vendor claims and identifying security flaws before they become issues to the end-users in the deployed system. It is also highly advisable to perform a vulnerability assessment across all the VoIP components prior to the deploying or commissioning of a VoIP infrastructure. At this stage interactions and dependencies between VoIP applications and devices (collectively referred to as assets herein) may create additional security vulnerabilities not visible during the lab stage assessments. Furthermore, periodic or, where justified, continuous vulnerability assessments may be performed as part of an internal security processes. Once potential security vulnerabilities are identified using the security assessment system, they may be addressed by appropriate actions such as patching, re-configuration and network tuning.

VoIP networks are being deployed in very large environments with potentially millions of phones residing on the same network. Previous centralized approaches to the vulnerability assessment cannot scale to the networks of this size and can fail to provide comprehensive security in large networks. The security vulnerability assessment system is a distributed application which allows for the scaling of the system for use in small to very large environments.

The security audit of VoIP networks has to have a minimal impact on VoIP QoS parameters such as delay or jitter. If the amount of test data sent over the VoIP network is too large, quality of voice conversation can be significantly affected to the point where the VoIP services are unusable.

The system described herein may limit the amount of test data by understanding the type of VoIP asset it is targeting and making appropriate decisions, using a database, on what type of traffic patterns would be possible to use in the process of testing without having negative impact on the device.

A distributed VoIP security vulnerability assessment system (VVA) is described. The VVA features include:
1. Distributed discovery of VoIP specific devices and applications (assets);
2. Identification of the type and the vendor of discovered VoIP assets;
3. Storing the results of the discovery in centralized persistent storage;
4. Construction of a comprehensive audit that is a combination of the discovered VoIP assets and applicable test cases stored in the persistent knowledge base;
5. Distributed execution of the constructed audit against the identified VoIP assets;
6. Receiving and storing results of the VoIP audit in the centralized persistent storage;
7. Calculating a VoIP security index for all audited VoIP assets; and
8. Presentation of audit results in multi-layered graphical and tabular formats.

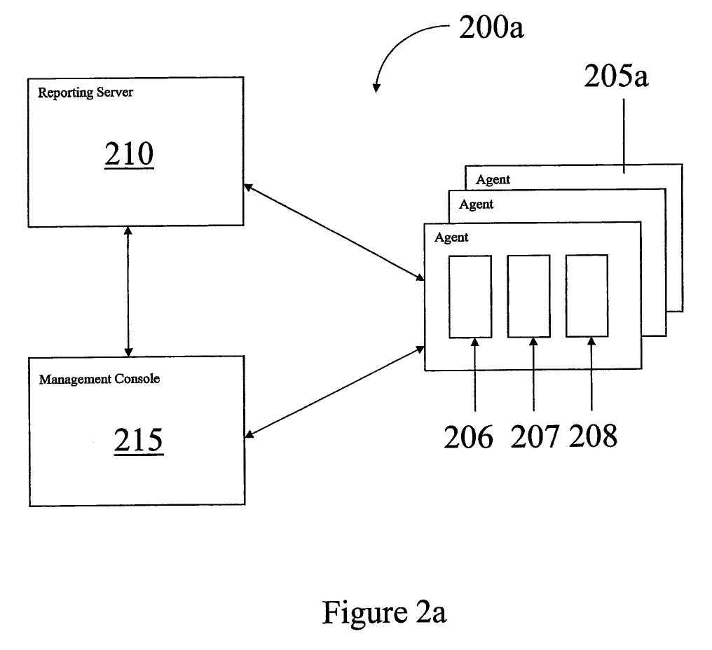

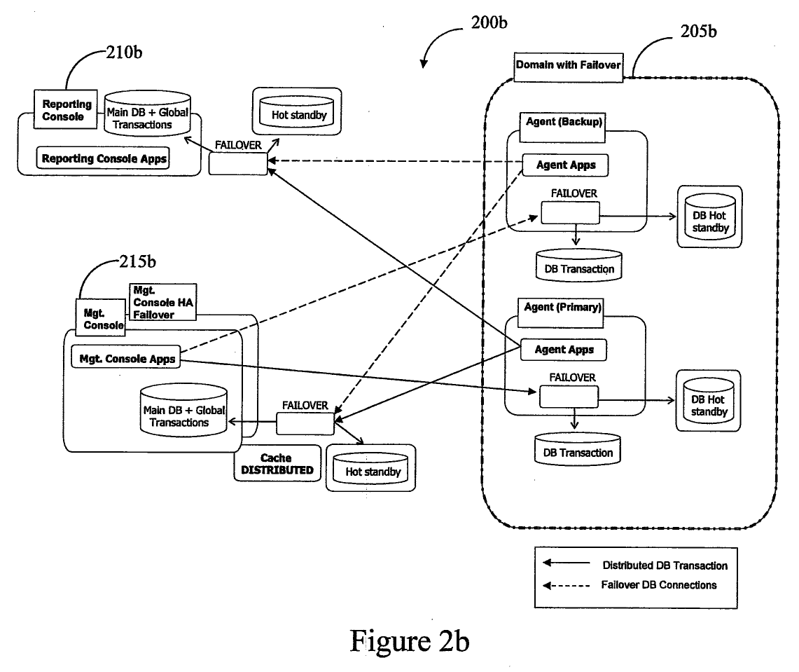

FIG. 2a shows in a functional schematic, components of the VVA system 200 in accordance with an embodiment of the present disclosure. They include a management console 215a, a reporting server 210a, and one or more agents 205a. The components can communicate via IP connections or other suitable network connections. The management console 215a and the reporting server 210a provide administration, configuration, storage and reporting functions. The management console 215a provides a user interface to the VVA system 200 that allows for the configuration of the system, input of information. For example, the management console 215a may be used to input information regarding the physical arrangement of the VoIP network, specify auditing parameters such as tests to be run, schedule periodic audits, etc.

The agents 205a may include a discovery module 206, an auditing module 207 and a storage module 208. The discovery module 206 discovers VoIP assets that are on a particular part of a network, for example described by a range of IP addresses. The discovery module 207 may discover and identify the VoIP assets on the network, and communicate this information back to the management console 215a. The audit module 208 may receive an audit to execute against VoIP assets. The audit may specify a test or tests to run against VoIP assets. The audit may be received from the management console 215a and may be based on the VoIP assets identified by the discovery module 206 as well as audit parameters. For example an audit may target only a specific asset for a specific security vulnerability. The storage module receives the audit information from the audit module 207 and stores the information in a local database. The storage module 208 may also send the information back to the management console 215a for storing in a central persistent store along with audit information received from other agents. Generally communication between the agents 205 is done using a centralized communication model, in which the agents communicate information about the audit results back to the management console 215a. However, there is some information passed between agents 205a that is indirectly related to the main goals of auditing. This information includes information that provides each agent with knowledge of other agents presence. For example when a new agent is initialized on a network, it may attempt to discover any other agents present on the network and announce its presence to them. Agents may also announce their exit to other agents. As such agents may form clusters, with new agents announcing their presence to the other agents and agents announcing when they leave the cluster.

FIG. 2b shows in a functional schematic, components of the VVA system 200b in accordance with an embodiment of the present disclosure. The VVA system 200b comprises a management console 215b, a reporting console 210b, and at least one agent 205b. The reporting module may aggregate information from agents and the management console into a unified database for reporting purposes. The VVA system 200b is similar to the VVA system of FIG. 2a, however the various components (2105b, 210b, 215b) are provided with failover backup components in case a component fails. All of the components are monitored by each other. As described above, the components may belong to one or more “clusters” which have full presence capability in order to detect when a new component enters the cluster, or when a component leaves the cluster. This allows components to come and go, for example due to error or other causes, transparently without damaging or impacting the underlying business processes, for example the discovery or auditing of VoIP assets. When a failure of a component is detected a hot-standby backup component is activated and dynamically added to the system configuration. Any change of membership of the cluster activates processes that will automatically pause, switch, re-direct appropriate resources or business processes to other components if available. As a result, changes of the cluster do not impact the business process in any way other than potentially delaying its time of execution. For example, if an agent fails (for example the computer it is running on crashes), the other components of the cluster will detect this and can then perform the processes the failed component was doing. For example, if an agent fails the management console may redistribute the auditing to the remaining agents. Alternatively the management console may start a new agent to perform the tasks of the failed agent. Similarly, if the management console fails, a failover management console may replace it to ensure the auditing process continues. The components maintain a hot-standby database. Database transactions are processed through a failover component that is responsible for maintaining the hot-standby database in the same state as the main database. The database is associated with the management console, and stores the state of components as well as all data and its state as can be seen on an agent's local database. This allows for full recovery and data integrity of any business processes that could be impacted by a hot-standby switch-over.

The VVA system 200 may perform multiple functions in assessing VoIP network security levels. The first function is to discover and identify the VoIP network assets. Once the assets of the VoIP network are identified, the VVA system 200 may construct and perform a security audit of the VoIP assets. Based on the security audit, the VVA system 200 may then determine VoIP security measures for providing security information about the VoIP network.

The discovery of VoIP network assets uses a six stage process. The stages include:
1. IP range scanning;
2. Fast VoIP specific port scanning;
3. Detection of VoIP services;
4. Fingerprinting specific VoIP application;
5. Additional information collection; and
6. Correlating all the collected information.

The first stage scans a range of IP addresses to determine if a VoIP asset is present at the IP address and tests for network availability of an IP device. The range of IP addresses scanned may be provided to the agent by the management console.

The second stage of the asset discovery process performs a fast VoIP specific port scan of all the IP assets determined in the first stage. For example, SIP (responsible for call signaling phase) traffic is typically initiated on port 5060, while H.225 (responsible for call signaling phase) requires entities to support signaling over TCP port 1720. The fast port scan is limited to the ports that the VoIP network uses, and may be based on the protocols used such as SIP, H.225, UNIStim, H.3223, H.248, MGCP, SCCP or other protocols. This stage can identify ports that are potentially being used by VoIP assets.

The third stage of the discovery process performs a stateful detection of VoIP services. The stateful detection of VoIP services determines the state of the application providing the VoIP service. This may be done by observing the messages between protocol participants and attempting to determine the state of the application using the observed information. A database of VoIP services or assets may be use to determine the service of the VoIP asset. The information gained is the actual services that sit behind a port. The system does not infer services based on the presence of a port, as some service may use a different port. Rather the third stage goes into more detailed processes to actually determine a services presence.

The fourth stage fingerprints specific VoIP assets. This may be done by issuing specific queries to the asset and correlating the response with known responses. This information may be used to determine asset information such as, for example, the version number, patches applied, vendor information etc.

The fifth stage collects additional information from assets that support SNMP, NetBIOS and WMI. The additional information collected may be used to provide information such as, for example, network traffic levels and asset configurations.

The sixth stage correlates the collected information with a knowledge base of vendors and applications to determine the instances of the discovered assets. The knowledge base of vendors and applications may be maintained and updated independent of the operation of the VVA system 200. This correlated information can be used to provide an overall view of VoIP network assets.

The discovery process is executed in a distributed fashion. The set of IP addresses requested to be discovered is automatically divided into a number of IP address ranges by the management console 215. The division may be based on the number of agents 205 residing on the network and the desired scope of the discovery. They management console may also divide the range based on locations that are available from particular agents if not all IP addresses are accessible to all agents. Each of the agents 205 is responsible for performing the discovery process for all or a subset of IP addresses For example, if the discovery spans 44 logical subnets in 44 different geographical locations, an agent may be present in each local geographic location. The management console knows the location of the agents, as well as the physical characteristics of the network, and partitions the top-level business process of “discover all 44 subnets” by sending the exact set of IP address which each agent will be responsible for. The IP addresses which are accessible to 1 agent might not be by another, the management console knows this and thus maintains what could be called a “responsibility” IP domain for each agent, which is a reflection of IP addresses that an agent can physically contact. The management console divides the discovery process among agents to ensure that all of the required IP range is discovered. The discovery configuration information that describes the IP ranges to be assigned to the various agents 205 may be stored in persistent storage and can be re-used multiple times. The discovery is then executed by each agent 205 in parallel. The partial results of the discovery are stored locally on the agent 205 and then communicated back to the management console 215. The management console 215 combines the partial discovery results received from the agents 205. The combined results provides a comprehensive view of the entire VoIP network.

In some cases automated discovery is not able to discover all the characteristics and attributes of a VoIP asset. For example a VoIP asset may sit behind a firewall that prevents the agent from discovering it. The VVA system 200 allows adding that information manually using the management console 215 user interface. Once the VoIP asset is added it will be included in further tests or audits performed by the agents.

The VVA system 200 may also perform a VoIP security audit. The audit is a relationship between discovered assets or their subsets and a list of VoIP security test cases relevant to the type of the asset. A test case may be a computer program, code or script that is executed during the audit for purpose of identifying VoIP specific security vulnerabilities on the target VoIP device. The audit may consist of multiple assets and multiple test cases in many-to-many relationships. However, in order to limit the bandwidth used during the auditing process, only tests specific to the VoIP asset are run.

The audit is performed in a distributed manner. The set of IP addresses requested to be audited is automatically divided into a number of IP address subsets, depending on the number of agents 205 residing on the network and the scope of the audit. Each of the agents 205 is responsible for auditing the range of IP addresses assigned to the agent 205 during the audit creation performed by the management console 215. During the audit creation the management console assigns IP ranges to particular agents, and determines tests to be run against the VoIP assets. The determination of the tests to be run are based on the test being applicable to the particular VoIP asset. The test may also be determined based on the completeness of the audit. For example a fast audit may be used to only test critical security vulnerabilities to main network infrastructure, such as VoIP soft switches. The audit configuration, that is the portion of the created audit for a particular agent, is sent to the agent over the network using secure distributed database transactions. The audit configuration information, for example the IP ranges audited by the agents 205 and the test cases to be used, is stored in persistent storage and may be re-used multiple times. The audit configuration may also be stored locally on the agent, and if it is the audit may be re-run without having to send the audit configuration again. The audit is then executed by each agent 205 in parallel. The partial results of the audit are stored locally on the agent 205 and then transported back to the management console 215. At the management console 215, the partial audits results received from the agents 205 are combined to provide comprehensive list of identified vulnerabilities on the VoIP assets being subject of the audit.

During the audit, agents 205 may utilize test cases that test targeted assets by first establishing a connection through a VoIP PBX/softswitch 105 using VoIP signaling protocols and authentication. Once the connection is established the system 200 executes test cases that cannot be executed without that connection being present.

The VVA system 200 allows for the manipulation of the scope of an audit by increasing/decreasing the number of targeted assets and increasing/decreasing the number of test cases executed against a specific asset by an assigned agent 205. The audit configuration information can be entered manually, determined from a previously stored audit configuration, determined from preconfigured audit configuration information, etc. In one extreme, an audit could be limited to a single asset and a single test case. In the other extreme, all the targets and all the test cases could be executed. The different audits may be used to perform varying levels of audits. For example a ‘basic’ audit may be performed daily, a ‘detailed’ audit may be performed monthly and a ‘full’ audit may be performed yearly. It is understood that this audit and schedule is given only as an example, and other audits and schedules may be used.

The VVA system 200 may calculate three unique indexes that can be used to provide an overview of the detailed VVA information. The indexes include:
1. Asset Security Index which qualitatively measures the risk of a particular VoIP asset being attacked. It may be calculated as an overall percentage, and takes into account the asset importance in the VoIP network, test coverage (number of vulnerabilities for which the asset was tested/total number of known vulnerabilities for the asset) as well as the severity of each vulnerability that was identified. Information relating to the severity of the vulnerability may be stored in persistent storage database and associated with the test case that tests for the vulnerability.
2. VoIPsec Index which qualitatively measures the overall risk of all VoIP assets on a specific network. The VoIPsec Index may be calculated as an overall percentage, and takes into account the Asset Security Index of each asset in the active networks, as well as the relative importance each asset represents to the overall health of VoIP services. Assets that have not been audited are also factored into the VoIPsec Index calculation, with an Asset Security Index value of, for example, 0%.
3. Vulnerability Impact index which expresses a potential impact of a given VoIP vulnerability on a particular VoIP asset. It is calculated as an absolute number derived from the vulnerability severity level and asset importance.
   As described above the VVA system 200 may discover and identify VoIP assets on a network, create a distributed audit to run against the assets, and calculate indices to summarize the results of the audit. The results of the audit, including the indices, may be displayed using a reporting component that allows an overview of VoIP network security as well as access to the detailed security information.

### Security Compliance Assessment System

A distributed VoIP security compliance assessment (VCA) system is now described. The VCA features include:
1. Distributed discovery of VoIP specific devices and applications (VoIP assets);
2. Identification of a type VoIP assets;
3. Storing the results of the discovery in centralized persistent storage;
4. Construction of a comprehensive security compliance audit that is a combination of the discovered VoIP assets and applicable compliance test cases stored in the persistent knowledge base;
5. Distributed execution of the security compliance audit against identified VoIP assets;
6. Receiving and storing results of the compliance audit in the centralized persistent storage;
7. Calculating VoIP compliance security index for all audited VoIP assets; and
8. Presentation of audit results in multi-layered graphical and tabular formats derived from the compliance audit results and internal mappings between the assets on the VoIP network and security policies.

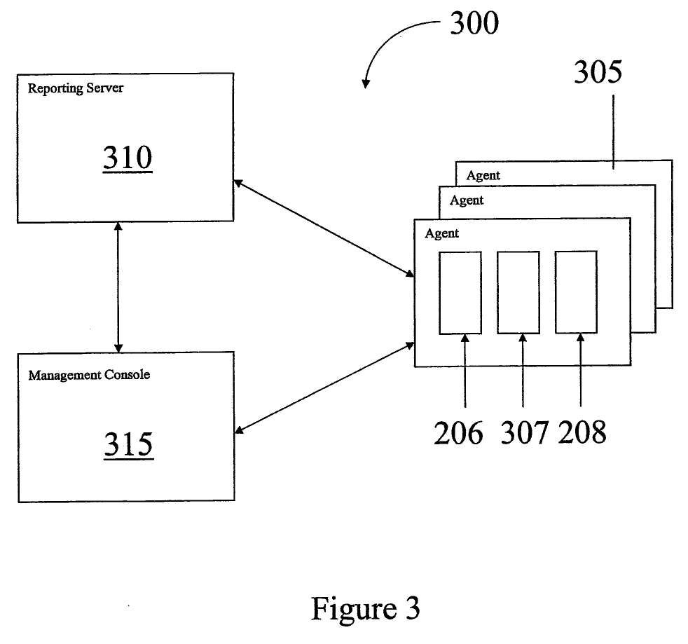

FIG. 3 shows in a functional schematic, components of the VoIP security compliance assessment (VCA) system 300 in accordance with an embodiment of the present disclosure. The VCA system 300 functions in a similar manner to the VVA system 200 previously described, however the agents 305 are modified to have a security compliance module 307 instead of a security audit module 207. The agents could be modified to include the security compliance module in addition to the audit module The management console 315, and the reporting server 310 are also modified for the entry, display, storage and manipulation of security compliance information instead of (or in addition to) security vulnerability audit information. It is understood that the VVA system 200 and the VCA system 300 could be combined into a single system, with agents that have both a compliance assessment module 307, and a security vulnerability audit module 207. The management console and report server may be modified to provide for the entry, display, storage and manipulation of both compliance related information and vulnerability audit related information.

A security compliance assessment is a process that takes results from a security vulnerability audit, which may be performed as described above, and combines the results with information in a compliance database to infer which assets are compliant and which are not compliant with a variety of compliance formats such as HIPS, GLBA, SOX, etc.

The compliance assessment module 307, or the management console 315, may calculate two unique indexes that can be used to provide an overview of the detailed VCA information:
1. Asset Security Compliance Index qualitatively measures the compliance of a particular network asset against a particular security policy. It is calculated as an overall percentage, and takes into account the asset assessment coverage (number of vulnerabilities related to a particular security policy for which the asset was tested/total number of known vulnerabilities related to the particular security policy for the asset, the severity of each vulnerability and the asset importance in the context of the security policy; and
2. VoIP Network Compliance Index qualitatively measures the compliance of all assets against a particular security policy. The VoIP Network Compliance Index is being calculated as an overall percentage, and takes into account the Asset Security Compliance Index of each asset, as well as the relative importance each asset represents to the overall compliance of VoIP network.

Assets that have not been audited are also factored into the VoIP Network Compliance Index calculation, with an Asset Security Compliance Index value of 0%.

The management console determines and sends an optimum set of tests to the agent to determine compliance of that asset based on asset information form the most recent discovery.

### Network Access Control System

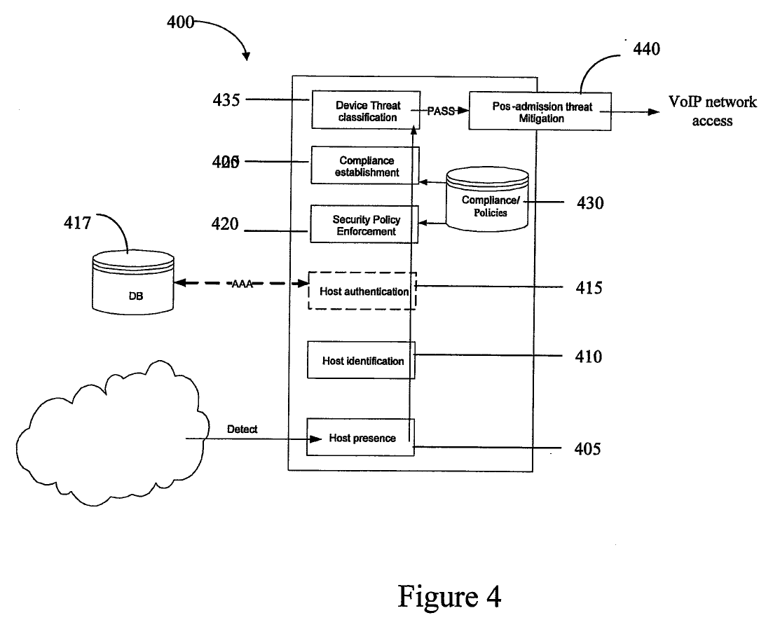

FIG. 4 shows in a functional schematic a VoIP Network Access Control (VNAC) system 400 in accordance with an embodiment of the present disclosure. The VNAC system 400 may include an asset presence detection module 405 for detecting the presence of an asset, an asset identification module 410 for identifying the detected asset, an asset authentication module 415 for authenticating the identified asset. The asset authentication module 415 may communicate with an authentication database 417. The VNAC system 400 may also include a security policy enforcement module 420 and a compliance establishment module 425 for determining if the authenticated asset complies with the established security policy. These modules, 420 and 425 may communicate with a compliance policies database 430. The VNAC system 400 may further include a device threat classification module 435 for classifying assets, and granting access (or denying access) based on the classification. A post-admission threat mitigation module 440 may be used to monitor assets after they have been granted access to the VoIP network.

The VNAC system 400 may provide dynamic IP address identification, asset identification, authentication, security audit execution, establishing compliance with predefined security policies, classifying device suitability for granting access to the VoIP network and post-admission threat mitigation.

The VNAC system 400 provides for access to VoIP network resources to be granted based upon authentication of the user and/or asset as well as verification of the asset's compliance to specific VoIP security policies.

The VNAC system 400 features include:
1. Non-destructive identification of a type of VoIP assets requesting access to the VoIP network. Non-destructive identification means that the operational state of the device will not be affected. In contrast, destructive tests could reboot or permanently change the settings or state of the device. This is beneficial for identifying assets dynamically as they attempt to access the VoIP network;
2. Authentication of the identified VoIP assets;
3. Executing pre-defined security assessment against the VoIP assets requesting access;
4. Receiving and storing results of the assessment in the centralized persistent storage;
5. Deciding if the device is granted access to VoIP network based on the results of the assessment;
6. Re-directing non-compliant assets to quarantine network;
7. Updating permanent black/white lists;
8. Post-admission monitoring the health and behaviour of the admitted device; and
9. Updating of test cases use for security audits stored in the knowledge base.
   The VNAC system 400 operates over any VoIP network such as enterprise or service provider networks. As previously described, the VoIP network typically includes VoIP softswitch or PBX, hard and soft phones, gateways, voice mail systems, conference servers, multi-media servers, call recorders, automated call distribution systems and interactive voice response systems. In peer-to-peer VoIP implementation VoIP PBX functionality is replaced with distributed call processing capabilities. The VNAC system 400 and method run in-line to the VoIP PBX or softswitch controlling access to these VoIP network resources. The VNAC system 400 typically sits at a perimeter point whereby it shields access to 1 or more PBX's behind it from systems/devices that attempt to access the PBX's services.

Unlike the VVA and VVC systems described above which identify assets connected to specified range of IP addresses, the VNAC system 400 dynamically identifies the IP address of VoIP assets attempting to connect to the VoIP network using information contained in the signaling protocol. After the VNAC system 400 has dynamically identified the IP addresses of VoIP assets, a fast discovery process is performed on the addresses. The fast discovery is similar to the discovery performed by the VVA and VVC systems but is a 5 stage process:
1. Fast VoIP specific port scanning of all the VoIP assets;
2. Stateful detection of VoIP services;
3. Fingerprinting specific VoIP applications by analyzing their response to a specific queries;
4. Additional information collection using SNMP; and
5. Correlating all the collected information with knowledge base of vendors and applications to determine the instances of these components.

The VNAC system 400 may the perform security compliance audit against the VoIP assets identified in the fast discovery. The VNAC system executes the compliance test cases against an identified asset and collects the results of the test cases. The VNAC system 400 may execute multiple compliance test cases against multiple assets in parallel. The VNAC system 400 may provide visual audit progress indicators to inform the asset of the current state of the security compliance audit execution.

The VNAC system 400 also calculates an Asset Security Compliance Index (ASCI) based on the result of the security compliance audit. The ASCI qualitatively measures the compliance of a particular network asset against a particular security policy. It is calculated as an overall percentage, and takes into account the asset assessment coverage (number of vulnerabilities related to a particular security policy for which the asset was tested/total number of known vulnerabilities related to the particular security policy for the asset) as well as the severity of each vulnerability in the context of the security policy.

The VNAC system 400 may then compare the calculated ASCI value with pre-defined values or thresholds and based on the results of the comparison grant (or deny) the VoIP asset access to VoIP network resources.

The VNAC system 400 may also update permanent allowed lists based on the ASCI value so that the VoIP assets are admitted to the VoIP network without any compliance testing in the subsequent attempts. The asset may be added to the permanent allowed list for a period of time, for example one week, after which a security compliance test may be run again against the asset. The VNAC system may also automatically update permanent denied lists based on the ASCI value so the VoIP assets are not granted access to the VoIP network without performing compliance assessment in subsequent attempts. An asset placed on the denied list may be sent to a quarantine area where the steps necessary address the identified security issues may be presented, for example applying a patch. If the asset performs the necessary actions in the quarantine area it may be removed from the denied list so that the next time the asset attempts to connect to the VoIP network it will again be tested for compliance with the security policies of the VoIP network.

The VNAC system 400 may constantly monitor traffic generated by the admitted VoIP assets for VoIP specific security threats. If such a threat is discovered the VNAC system 400 will block that asset and inform the system operator.

The VNAC system 400 can be used to identify high risk assets and so allot greater resources to tracking the asset's activities. Furthermore, assets that conform to strict compliance testing can be allowed access to the VoIP network with little or no additional monitoring. As a result less bandwidth and time is used in compliance testing and monitoring, which allows for better QoS. The additional monitoring may monitor the packets sent by the asset and compare the packet information with known attack fingerprints stored in the knowledge base. The additional monitoring may also monitor the message states to ensure compliance with the particular protocol used.

As described above the VVA 200, VCA 300 and VNAC 400 systems provide for fast discovery and identification of VoIP assets and testing of the VoIP assets. The VVA and VVC systems each receive a range of IP addresses to discover, while the VNAC system uses dynamically discovered IP address.

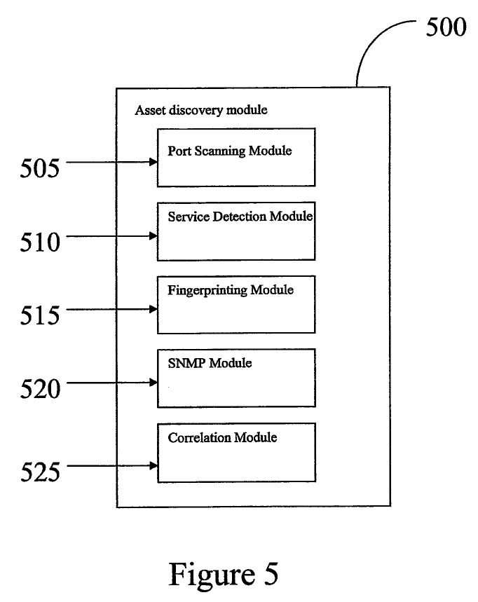

FIG. 5 shows in a functional schematic an asset discovery module 500 in accordance with an embodiment of the present disclosure. The asset discovery module 500 may be used by the VVA system 200, the VCA system 300 or the VNAC system 400. The asset discovery module 500 has a port scanning module 505 for performing fast VoIP specific port scanning of VoIP assets, a service detection module 510 for performing stateful detection of VoIP services, a fingerprinting module 515 for fingerprinting specific VoIP applications by analyzing their response to specific queries, an optional SNMP module 520 for collecting additional information using SNMP, and a correlation module 525 for correlating all of the collected information with a knowledge base of vendors and applications to determine the instances of these assets.

The asset discovery module 500 can be provided with IP addresses to discover. The IP addresses may be provided by a specific IP address range, as is used in the VVA 200 and VCA 300 system. Alternatively the IP addresses may be provided by dynamic IP detection using signaling protocol information, as is done in the VNAC system 400.

The different systems 200, 300, 400 perform these tasks in various ways that are suited for what they are used for. For example, the VVA 200 and VCA 300 identify VoIP assets by first identifying all assets using an IP range scan. The VVA 200 and VCA 300 systems can be used to test and maintain the security of a network over long time periods. As such, it is desirable to identify all VoIP assets using the IP scan. The VNAC system 400 may be used to grant real time (or near real time) access to VoIP network resources. As such, it uses information obtained from the signaling protocol to identify assets that should be considered.

The tests performed by the different systems can also be varied depending on what the system is used for. For example in testing VoIP network infrastructure prior to being commissioned it may be desirable to test, using the VVA system 200, all assets against all known security vulnerabilities. This information could be used to determine security policies that assets on the VoIP network must adhere to. The VCA system 300 can be used to ensure that assets on the VoIP network do adhere to these policies. The VNAC system 400 may use more specific compliance testing to ensure that undesired assets are not accessing VoIP network resources. For example if a VoIP virus is known to be spreading in other VoIP networks, the VNAC system 400 can be used to ensure that all assets that are granted access to the VoIP network are not vulnerable to the attack. Additionally or alternatively, the VNAC system 400 could be used to identify assets that should be monitored closely.

### SPIT Blocking System

The above systems provide a measure of security for VoIP networks, however it may still be necessary to detect and block unwanted access, such as from Spam over Internet Protocol Telephony (SPIT) traffic. In order to quickly identify SPIT traffic, a SPIT blocking system is described. The features of the SPIT blocking system include:
1. Identification of SPIT messages coming from outside or inside VoIP network;
2. Adding sender of the SPIT messages to permanent denied access list;
3. Adding trusted sources of voice calls to permanent allowed access list; and
4. Process end-user input to the system for qualifying calls as SPIT or legitimate.

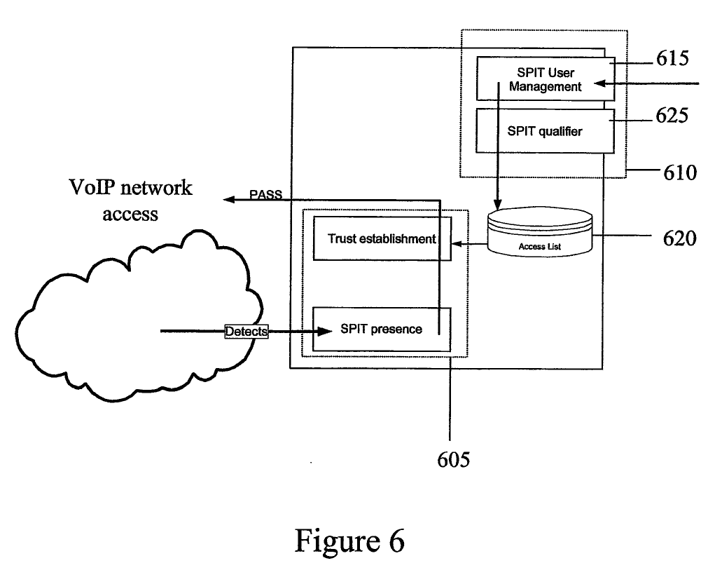

FIG. 6 shows in a schematic a SPIT blocking system 600 in accordance with an embodiment of the present disclosure. The SPIT blocking system includes SPIT detection engine 605, and a correlation engine 610. The correlation engine may include a user feedback mechanism 615 and a spit qualification module 625.

The SPIT blocking system 600 operates over any VoIP network such as enterprise or service provider networks. As previously described, the VoIP network typically includes VoIP softswitch or PBX, hard and soft phones, gateways, voice mail systems, conference servers, multi-media servers, call recorders, automated call distribution systems and interactive voice response systems. In many cases these network can have a distributed nature, for example, a single central site with hundreds of branch offices. In other cases a service provider could have millions of end-point distributed throughout very large geographical areas. In peer-to-peer VoIP implementation VoIP PBX functionality is replaced with distributed call processing capabilities. The system runs in-line to the VoIP network processing all the inbound VoIP traffic.

The SPIT blocking system 600 uses a SPIT detection engine 605 that dynamically identifies SPIT messages by observing signaling and real-time transport protocols behavior, and by using pre-defined security policies. The SPIT blocking system 600 may receive end-user messages that subjectively qualify a particular voice mail or a call as SPIT. The messages from a number of the end-users and behavior of VoIP traffic are used to calculate a SPIT Index (SI) associated with an asset. The system may automatically updates permanent access lists 615 based on the SI value so that calls from these callers are admitted to the VoIP network without any testing in the subsequent attempts. The system may also automatically update permanent denied lists 615 based on the SI value so that VoIP devices or applications are not granted access to the VoIP network in subsequent attempts by the asset.

The SPIT detection engine 605 uses the denied lists 615 to quickly and efficiently reject SPIT traffic. For example, if a SPITTER sends out numerous SPIT messages (for example to voice mailboxes), users may be given the opportunity to submit the message as SPIT. This may be accomplished by the push of a button, or other triggering event, which would send the message information to the SPIT blocking system. If a certain number of users submitted the same asset as providing SPIT messages, the SI index would increase until the asset was placed on a denied list 615 and any further attempts to access the VoIP network by the asset would be denied.

The system 600 may keep an SI value for assets that have accessed the VoIP network. The SI value may be calculated in various ways. As described above, it may be based on user feed back using a user feedback mechanism 615. Additionally the SI value may be determined from information contained in the signaling protocols. This information could be correlated, by a SPIT qualification module 625, with additional information to determine the likelihood that a message is SPIT. This additional information could include current information about known SPITTERS, such as their country of origin, times that calls are typically placed etc. By using this information it is possible to assign an SI value to assets.

The SPIT blocking system 600 as described is flexible in that the SPIT detection engine 605 uses denied lists 620 to block traffic (or allowed lists 620 to allow traffic without any further inspection or monitoring). The detection engine 605 can quickly identify an asset from signaling information (whether it is SIP or other signaling protocols such as SCCP, UNIStim, H.323, H.248, MGCP) and then determine if the asset is on the denied list 620. If it is the traffic is not allowed on the VoIP network. If the asset is on the allowed list 620, it is allowed without any further inspection or monitoring. If the traffic is not on the either list 620, the asset may be identified and information from the signaling protocol used to create or update an SI value for the asset.

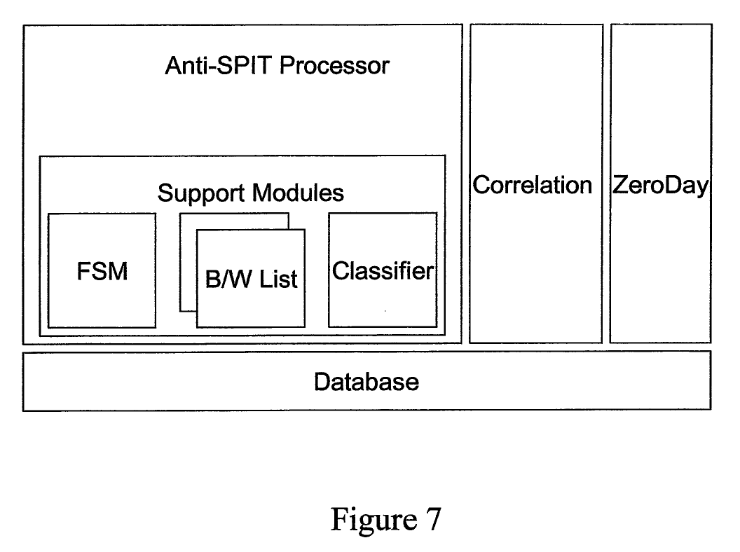

FIG. 7 depicts the system architecture of a further embodiment of the SPIT blocking system 600. The SPIT blocking system 600 comprises a preprocessor module 7005, a correlation module 715 and a zero day module 717. These modules may retrieve and store information to a database 719. The information stored and retrieved from the database facilitates the identification of messages as SPIT. The information may include system parameters such as throttling thresholds and anti-SPIT policies. The system parameters may be used to tune the performance of the SPIT blocking system 600. The information may also include additional information such as user reputation information and SPIT patterns. The user reputation information may be used in determining the likelihood that a message sent from a user is SPIT. The SPIT pattern may be used in determining if a message is SPIT by matching the SPIT pattern to the message.

The SPIT blocking system 600 analyses the network traffic to mitigate SPIT. The Anti SPIT system 600 analyses various information, including information included in Network, Transport and Application layer protocols, the content of messages, the behaviour of messages sent between a source and destination, a user's reputation as well as user feedback. Based on the analysis of the various information the anti SPIT system 600 can provide real-time detection of SPIT. The anti SPIT system may also discover SPIT specific behaviour. The anti SPIT system may be adapted to the specific nature of an organization, for example using characteristics of the network traffic. The SPIT blocking system may also minimize the affect of SPIT messages passing onto the network, for example by limiting the available bandwidth to a sender.

The SPIT blocking system uses various techniques in order to mitigate the problems associated with SPIT. Referring again to FIG. 7, the SPIT blocking system 600 utilizes a preprocessor component 705 to observe packets on the network. The preprocessor component may capture packets for further processing or analysis. For example, the preprocessor may use kernel packet queuing techniques with a rule based application filtering system to capture packets that are to be further processed. Other types of packet capturing may be possible, such as, for example, copying all packets to a location and processing them to determine the required packets for further processing.

As depicted in FIG. 7, the preprocessor may also include various support modules 707 for further processing and analyzing the captured packets. The support modules (referred to generally as 707) may include a finite state machine module 709, a black/white (B/W) list module 711 and a classifier module 713. The support modules process and analyses the captured packets in order to provide various functionality to the SPIT blocking system 600.

The B/W list module 711 may be used to block packets from a sender (or possibly a receiver). For example, if a packet is sent from a location that is on the black list, the B/W module prevents the packet from entering (or exiting) the network. By contrast, if a packet is sent from (or destined to) a location on the white list, the B/W module 711 will allow the packet to enter (or exit) the network with out any further processing.

A location may be considered as being on a grey list. Although there may be no actual grey list, any location that is not on the black list or white list can be considered to be on the grey list. Packets sent to or from a location that is on a grey list may be marked for further processing or analysis. For example, the packets may be further processed by the FSM module 709 and classifier module 713 in order to determine the likelihood that they are SPIT. The packets may be copied to a database for further offline processing to determine specific SPIT patterns.

The individual packets observed may be used by the FSM module to validate message correctness. For example, the FSM module 709 can analyze the packets to determine if the format, state, order, etc of messages is correct for the protocol or application being used. Thus the FSM may check the frequency of messages to or from a target (or location). The FSM module 709 may also validate the message correctness and the state and order of messages. This information is validated against the particular messaging protocol used, for example SIP. Although SIP is described it is understood that other protocols including proprietary protocols may be validated.

If a message is validated (for example the frequency of messages to the target is not too high, and the state and other protocol information is validated) the packet may be processed by the classifier module 713. The classifier module 713 may determine a SPIT level for a message based on the analysis of the packet performed by the FSM module 709. The classifier may also determine what data is to be recorded for further offline analysis. The classifier module may also define a time slice associated with the SPIT level of the packet. The time slice may be defined based on pre-configured parameters. The classifier module 713 may also update the black list based on the SPUT level and time slice of the packet.

As described above, the B/W module 711 uses a black list to block locations, and a white list to allow packets from a location onto the network without further processing. It is possible to use different B/W lists. For example, a long term B/W list may be used to block locations that are known to produce SPIT continuously. A short term list may be used to temporarily block a location that may be producing SPIT only temporarily, for example as a result of a SPITter gaining access to a network. It is understood that the B/W module 711 may use the short term and long term lists in the same way. That is, for example, the B/W module 711 may block a location that is on the black list regardless of if it is the short or long term black list.

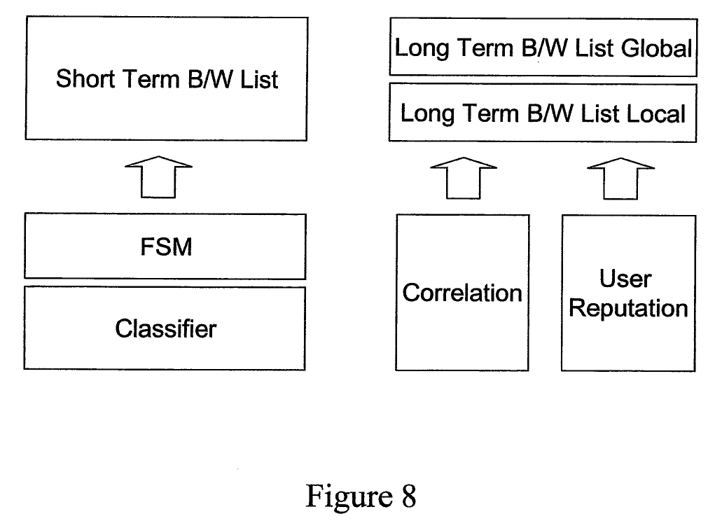

FIG. 8 depicts in a schematic components for maintaining B/W lists. As described above and shown in FIG. 8, two B/W lists may be maintained. A short term B/W list 805 may be maintained. The short term B/W list is maintained by the FSM module 709 and the classifier module 713. This allows for locations to be temporarily blocked if the system detects SPIT originating from the location. The location may be placed on the short term B/W list 805, for a period of time. The time may be specified by the time slice determined by the classifier module 713 based on a classified SPIT level. The use of the FSM module 709 and the classifier module 713 to update the and maintain the B/W list allows the SPIT blocking system 600 to respond quickly to new possible SPIT attacks.

A long term B/W list may be maintained by the correlation module 715 as well as user reputation and feedback information 815. When the classifier module 713 places a location on the B/W list, packet information sent from that location may be copied and stored for further analysis by the correlation module 715. The correlation module may perform the analysis offline, that is the analysis of the packet information does not affect the delivery of the packet, and may be performed some time after the packet has been copied. The offline analysis by the correlation engine may result in a location being placed on the long term B/W list.

As an example highlighting the difference between the short term and long term B/W lists, a particular location may start sending SPIT messages, the FSM module 709 and classifier module 713 will detect this and place the location on to the short term B/W list 805 in order to block messages from the location temporarily. If the location subsequently stops sending SPIT messages, the location may be removed from the short term B/W list. The messages received from the location are copied for analysis by the correlation module 715. The correlation engine determines if the location should be placed on the long term B/W list 810. For example the correlation module 715 may determine that the location has been sending SPIT messages for a period of time longer than the time used by the short term B/W list. The correlation module 715 may further apply heuristic methods for detecting SPIT messages and determining the amount of SPIT messages sent to or from a location. The user reputation or feedback 815 may also be used to determine if a message is SPIT, and if the location should be placed on the B/W list. The user may provide feedback for example by pressing a particular phone key when a SPIT message is received or by another similar means. The user reputation and feedback 815 may also be used to add locations to the white list of the long term B/W lists 810. For example a user may wish that any messages received from locations or telephone numbers in their contact list, or any numbers or locations they have called be added to the white list of the long term B/W lists 810.

As described above, The B/W list support module 711 provides a way to block (or allow) messages from locations. The B/W lists may be maintained by the FSM module and classifier in order to quickly identify and mitigate new SPUT sources. The correlation module may be used to further analysis information to determine locations to be added to long term B/W lists. The use of the short term and long term B/W lists provides both accurate detection of known SPIT messages using the correlation module as well as rapid detection and response to unknown possible SPIT messages using the FSM module 709.

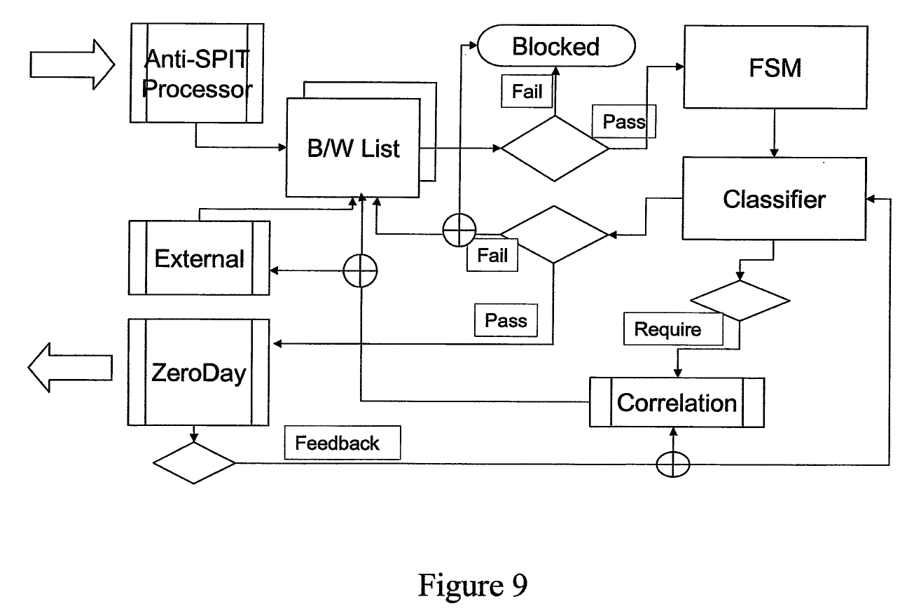

Referring to FIG. 9 there is shown in an exemplary flow diagram of the SPIT blocking system 600. The flow begins by receiving packets at the preprocessor 705. The preprocessor can be used to filter out all packets other than packets associated with VoIP traffic. The filtered packets are then processed by the B/W list module 711. If the packet location, for example the source or destination IP address, is determined to be on the black list (either the long or short term), thee packet fails the B/W module testing and is blocked from the network. If the packet location is on the white list, the packet passes the B/W module test and the packet is allowed onto the network without further processing. If the B/W module 711 determines that the location of the packet is not on either the black or white list it is considered to be on the gray list and will be processed further. The gray list packet is passed to the FSM 709 where the state and order of the message protocol is validated as well as the message correctness. The FSM module may also test the frequency of messages to see if they are above a set threshold. Once the FSM module 713 has validated the message it is passed onto the classifier which classifies the message according to a SPIT level. The classifier may also decide on a time slice based on the SPIT level. If the message is below a threshold SPIT level it passes the classifier and is processed by the Zero day module 715. Messages that fail the classifier module (i.e. messages with a SPIT level above the threshold value) are blocked from the network. The blocked messages may be used to update the B/W module, for example by adding the location of the sender to the short term B/W list. In addition the classifier module 713 decides on message to copy and save for further analysis. The messages that are copied are analyzed by the correlation module 715. The analysis performed by the correlation module may use heuristic methods to detect SPIT messages and may update the B/W module with the information.

Although the use of the system described above detects SPIT messages in real time, it may not detect all SPIT messages. As such it is desirable to mitigate problems associated with SPIT messages. The zero day module 717 may be used to throttle the available bandwidth in order to mitigate problems of SPIT messages entering the network.

The systems and methods according to the present patent disclosure may be implemented by any hardware, software or a combination of hardware and software having the above described functions. The software code, either in its entirety or a part thereof, may be stored in a computer-readable memory. Further, a computer data signal representing the software code which may be embedded in a carrier wave may be transmitted via a communication network. Such a computer-readable memory and a computer data signal are also within the scope of the present patent disclosure, as well as the hardware, software and the combination thereof.

While particular embodiments of the present patent disclosure have been shown and described, changes and modifications may be made to such embodiments without departing from the true scope of the patent disclosure

What is claimed is:

1. A VoIP asset discovery system for discovering and identifying VoIP assets on a VoIP network, the asset discovery system comprising:
an IP address module for determining at least one IP address to discover;
a port scanner for scanning VoIP specific ports of the received IP addresses;
a service detection module for detecting a VoIP service at the received IP addresses;
a fingerprinting module for fingerprinting VoIP applications based on responses received to specific queries; and
a correlation module for correlating the information from the port scanner module, the service detection module, and the fingerprinting module to identify the instances of the discovered assets.

2. The VoIP asset discovery system as claimed in claim 1, wherein the IP address module performs dynamic IP address discovery based on signaling information of a signaling protocol used by the VoIP network.

3. The VoIP asset discovery system as claimed in claim 1, wherein the IP address module receives a range of IP addresses.

4. The VoIP asset discovery system as claimed in claim 1, further comprising an SNMP module for collecting additional information from an IP address using SNMP, wherein the correlation module includes the additional SNMP information when correlating the information.

5. The VoIP asset discovery system as claimed in claim 1, further comprising a test module for performing tests on the discovered VoIP assets.

6. The VoIP asset discovery system as claimed in claim 1, wherein the tests are determined based on the correlated information from the correlation module.

7. The VoIP asset discovery system as claimed in claim 5, wherein the tests comprise security vulnerability audit tests.

8. The VoIP asset discovery system as claimed in claim 5, wherein the test comprise security compliance assessment tests.

9. A VoIP network security system for providing security measures to a VoIP network comprising:
a plurality of agents for discovering assets connected to the VoIP network, and for executing test on the discovered assets;
a management console for managing the plurality of agents, and for providing a user interface to the VoIP network security system; and
a reporting server for managing the storage of information and for creating report information.

10. The VoIP network security system as claimed in claim 9, wherein the tests comprise security vulnerability audit tests.

11. The VoIP network security system as claimed in claim 9, wherein the tests comprise security compliance assessment tests.

12. The VoIP network security system as claimed in claim 11, further comprising a test report generator for generating a vulnerability index value, an asset security index value, and a VoIPSec index value based on security vulnerability audit tests results for an asset.

13. The VoIP network security system as claimed in claim 12, further comprising a test report generator for generating a asset security compliance index value, and a VoIP network compliance index value based on security compliance assessment test results.

14. The VoIP network security system as claimed in claim 9, wherein the agents are distributed on the network.

15. A SPIT blocking system for blocking SPIT traffic on a VoIP network, the SPIT blocking system comprising:
a SPIT detection engine for detecting SPIT traffic using a banned list;
an asset rating system for associating a SPIT index value with an asset;
a list manager for maintaining the banned list, wherein an asset is added to the banned list if the associated SPIT index value is greater then a threshold value.

16. The SPIT blocking system as claimed in claim 15, wherein the asset rating system inspects signaling message information and compares with known SPIT message profiles to determine an associated SPIT index value.

17. The SPIT blocking system as claimed in claim 16, farther comprising:
an allowed list for identifying assets that are allowed access to the VoIP network, wherein the asset rating system does not inspect signaling messages of assets on the allowed list.

18. The SPIT blocking system as claimed in claim 15, wherein the asset rating system includes a user feedback system for allowing a user of the VoIP network to identify a received message as SPIT.

19. A method for discovering and identifying VoIP assets on a VoIP network, the method comprising the steps of:
determining at least one IP address to discover;
scanning VoIP specific ports of the received IP addresses;
detecting a VoIP service at the received IP addresses;
fingerprinting VoIP applications based on responses received to specific queries;
correlating the information from the scanning of VoIP specific ports, the detecting of the VoIP service, and the fingerprinting of VoIP applications; and
identifying instances of the discovered assets using the correlated information.

20. A method for providing security measures to a VoIP network, the method comprising the steps of:
discovering assets connected to the VoIP network;
executing tests on the discovered assets;
managing a plurality of agents used in discovering the assets and executing tests;
providing a user interface to the VoIP network security system;
managing the storage of information; and
creating report information.

21. A method for blocking SPIT traffic on a VoIP network, the method comprising the steps of:
detecting SPIT traffic using a banned list;
associating a SPIT index value with an asset;
maintaining the banned list comprising:
adding an asset to the banned list when the associated SPIT index value is greater then a threshold value.
